(19) United States
(12) Patent Application Publication
(10) Pub. No.: US 2014/0315233 A1
(43) Pub. Date: Oct. 23, 2014

(54) BUFFERED HISTOLOGY AND CYTOLOGY STAINS

(71) Applicant: HCI SCIENCES, LLC, Minden, NV (US)

(72) Inventor: Jerry Fredenburgh, Carson City, NV (US)

(73) Assignee: HCI Sciences, LLC, Minden, NV (US)

(21) Appl. No.: 13/866,676

(22) Filed: Apr. 19, 2013

(51) Int. Cl. G01N 1/30

(52) U.S. Cl. CPC G01N 1/30
USPC 435/29; 436/86

(57) ABSTRACT

A composition for use in staining histological and cytological tissue and cell samples which includes a buffer component in a staining solution. Specifically, the invention relates to stains and methods of producing stains for histological and cytological microscopic evaluation of tissue and cells. The buffer component is adjusted to a pH range below the isoelectric point (IEP) necessary to charge the protein or protein moiety of interest. The composition of a dye and solvent with a buffer component is particularly useful in obtaining controlled staining specificity of tissue elements or components, increasing reproducibility of the staining results, and increasing shelf-life of the staining reagent.

### BACKGROUND OF THE INVENTION

The present invention relates to the field of biological stains and methods of producing the stains. Specifically, the invention relates to stains for use in histology and cytology.

The invention is used to provide differentiating contrast between tissue and cell components. The invention is most generally used in the hematoxylin and eosin staining procedure and the Papanicolaou staining procedure, but is not limited to these procedures alone.

In the preparation of histology and cytology samples for microscopic analysis, dyes are used to stain tissues, cells, and cell components to facilitate their examination with light microscopy. The dyes stain cellular components with different tinctorial colors, differentiating cell components, thus allowing cells which are morphologically abnormal to be distinguished from normal cells and/or for the use of studying tissue and/or cells.

Staining solutions such as hematoxylin, eosin-Y, phloxine-B and eosin-Y combined, and Papanicolaou stain have been used for some time with satisfactory results. However, there has been a need for stains possessing greater specificity, with reproducible staining results from day to day, while maintaining cell transparency. It is also desired to increase the shelf life of staining solutions. With the advent of automated image analysis systems, for analyzing tissue and cell morphology, and of digital imaging, the above needs have increased greatly.

The lack of tinctorial discrimination of staining solutions and other stain related problems discussed herein is in part due to the pH of the staining solution in its relationship to the isoelectric point (IEP) of the target protein or protein moiety to be stained. This is particularly event when acid dye staining solutions such as eosin, phloxine eosin, and Papanicolaou stains are used as cytoplasmic chromogen markers. At times, an evident lack of cytoplasmic discrimination is noted, and it is commonly referred to as muddy cytoplasm staining. Evidence of this same phenomenon is also seen with anionic dye such as hematin dye lakes (commonly referred to as hematoxylin staining solution), used to differentiate nuclear chromatin from cytoplasm and cytoplasmic components.

Traditional acid is added to anionic and cationic staining solutions to adjust their pH. Presently, buffers are not used to stabilize desirable specific pH ranges for target protein or protein moiety of cytoplasm or nuclear chromatin. In the absence of a buffer, pH values can move based on the dye concentration, dye solution solvent evaporation, long term storage and the volume of slides processed on a day to day basis. Traditional buffers have not been used in staining solution for histological and cytological staining solutions to stabilize pH values.

### SUMMARY OF THE INVENTION

In accordance with the present invention, a staining composition containing a buffer to maintain a specific pH range is incorporated into the staining solution or staining reagent. The molar concentration is suitable to maintain the desired pH value or range of a specific staining solution or staining reagent 1) when tissue or cell samples are stained in the staining solution or staining reagent from day to day, 2) during long term storage, and 3) when dye solvent evaporation takes place. The invention includes all buffers useful in maintaining pH values in all staining solvents for use in histology and cytology.

The present invention includes the step of adjusting and maintaining the pH range of the staining solution, such that the pH is at or below the isoelectric point (IEP) of the protein or protein moiety to be stained.

The preparation of staining solutions and/or reagents with the invention provides a more accurate staining of biological samples such as tissue and cell components, through increased clarity of tinctorial differentiation of specific protein or protein moiety of interest.

A principal object of the present invention is to provide for a stabile pH of a staining solution. The pH stabilization of specific acid staining solutions does not allow the dye content to convert to a free acid and nonspecifically bind to tissue and cell components due to hydrogen bonding. Examples of such dyes are eosin-y and phloxine-B; at pH 4 and below, eosin-y and phloxine-B are converted to a free acid which stains non-specifically not allowing for high-quality cytoplasmic differentiation.

Another principal object is to provide a method by which the pH of the staining solution is at or just below the pK of the target protein or protein moiety allowing the target protein or protein moiety to be fully charged.

Another principal object of the present invention is to provide a means via buffer to pH balance staining solutions/or reagents used in histology and cytology for improved tinctorial differentiation of tissue and cell components and elements.

Another object is to provide clear cytoplasmic differentiation with buffered staining solutions/reagents with a complement pH range to pK range of tissue or cell cytoplasmic component(s) and element(s) to be stained.

Another object is to provide nuclear protein (nuclear chromatin) differentiation with the aforesaid invention with a buffered pH nuclear staining solution/reagent with a complement pH range to pK range of the nuclear chromatin or nuclear protein of interest.

Another object of the invention is to provide a stain which can be used in traditional alcoholic and aqueous dye solvents used in histology and cytology for the differentiation of tissue and cell component(s) and element(s) to be stained.

Another object of the invention is to provide buffered nuclear and cytoplasmic biological staining reagents that assure more accurate tissue and cell differentiation through the pH of the staining solution/reagent and its pK relationship of specific staining results.

Another object of the invention is to assure a longer shelf-life of a biological staining solution/reagent by not allowing for a shift in pH which has a definite impact on staining quality.

The reader skilled in the art will recognize other objects and advantages of the present invention, from a reading of the following detailed description of the invention and the appended claims.

### DETAILED DESCRIPTION OF THE INVENTION

The invention relates to a method of producing staining solutions or reagents used for the study or analysis of tissue or cells that incorporate the uses of a buffer system to maintain a specific pH range.

Compositions which may be prepared in accordance with the invention include biological stains which employ dyes in aqueous, alcoholic, glycol/diol or mixtures thereof as dye solvents, and thus include acidic and basic dyes, as well as direct and mordant dyes.

According to the present invention, a staining solution is provided with one or more buffer components. The invention includes adjusting and maintaining the pH range of the staining solution, such that the pH is at or below the isoelectric point (IEP) of the protein or protein moiety to be stained.

The following examples describe buffers used to maintain the pH of staining solutions. The invention is not limited to the buffers cited in the examples but applies to any buffer capable of achieving a pH value for dyes incorporated into the use of staining/reagents relative to pH or pK values for use in histology and cytology.

### Example 1

A mixture includes an equivalent amount of about one liter of 60% ethanol/water; buffered with 0.5M acetate buffer to a pH range of 4.6 to 5.0, and about 5.0 grams of eosin-Y.

### Example 2

A mixture includes an equivalent amount of about one liter of 60% ethanol/water, about 6.5 grams of eosin, about 0.65 grams of phloxine B, 0.5M acetate buffer in 60% ethanol in water in a ratio to maintain a pH range of 4.6 to 5.0.

### Example 3

A mixture includes an equivalent amount of about one liter of 60% ethanol/water, about 6.5 grams of eosin, about 0.65 grams of phloxine B, 0.5M acetate buffer in 60% ethanol in water in a ratio to maintain a pH range of 4.6 to 5.0.

The prior art, which uses alcoholic and aqueous dye solvents in histology and cytology, traditionally does not incorporate the use of buffers to maintain pH values, specifically in the use of hematoxylin solutions, eosin solutions, phloxine solutions and Papanicolaou staining solutions.

The invention can be modified in various ways, which will be apparent to the reader skilled in the art. Such modifications should be considered within the spirit and scope of the following claims.

What is claimed is:

1. A method of making a staining solution, used for staining histological and cytological tissue and cell samples, the method comprising:
a) determining the isoelectric point (IEP) of a protein or protein moiety to be stained,
b) providing a staining solution including one or more buffer components so as to adjust and maintain a pH range in the solution at or below the isoelectric point of the protein or protein moiety to be stained.

2. The method of claim 1, further comprising selecting the staining solution from the group consisting of a concentrated solution and a stock solution, and diluting the solution to obtain a working staining solution.

3. The method of claim 1, further comprising selecting the solution to include solvents selected from the group consisting of aqueous solvents, alcoholic solvents and glycol/diol solvents.

4. The method of claim 1, further comprising selecting the staining solution to include eosin-Y, and selecting the buffer components to include an acetate buffer.

5. The method of claim 1, further comprising selecting the staining solution to include eosin and phloxine B, and selecting the buffer components to include an acetate buffer.

6. The method of claim 1, further comprising selecting the staining solution to include eosin and phloxine B, and selecting the buffer components to include an acetate buffer in ethanol in water.

7. A composition for use in staining histological and cytological tissue and cell samples, comprising a stain material in a solution, and a buffer, wherein the buffer maintains a pH of the solution at or below an isoelectric point (IEP) of a protein or protein moiety to be stained.

8. The composition of claim 7, wherein the stain material comprises eosin-Y, and wherein the buffer includes an acetate buffer.

9. The composition of claim 7, wherein the stain material comprises eosin and phloxine B, and wherein the buffer includes an acetate buffer.

10. The composition of claim 7, wherein the stain material comprises eosin and phloxine B, and wherein the buffer includes an acetate buffer in ethanol in water.
